(19) United States
(12) Patent Application Publication
(10) Pub. No.: US 2013/0330681 A1
(43) Pub. Date: Dec. 12, 2013

(54) Canine Dental Tool and Method of Canine Dentistry

(71) Applicant: Margot Sacks, Wall Township, NJ (US)

(72) Inventor: Margot Sacks, Wall Township, NJ (US)

(21) Appl. No.: 13/914,014

(22) Filed: Jun. 10, 2013

Related U.S. Application Data
(60) Provisional application No. 61/657,117, filed on Jun. 8, 2012.

(51) Int. Cl. A61D 5/00

(52) U.S. Cl. CPC A61D 5/00
USPC 433/1

(57) ABSTRACT

A hand-held canine dental cleaning tool is provided having a hand-held base adapted to be held in a person's hand and a vibrating unit disposed within the base. A scaling head is disposed at a distal end of the base and in communication with the vibrating unit. When the vibrating unit vibrates, the scaling head oscillates in a manner adapted to remove calculus from canine teeth when applied thereto. The scaling head is preferably curved, e.g., substantially in the shape of a shepherd's hook and/or angled or substantially L-shaped, and preferably includes a flattened shovel-like tip or very dull tapered tip. Preferred oscillations of the scaling head are in the range of 2-10 mm at approximately 5000-10,000 Hz. The scaling head is preferably interchangeable with a toothbrush head and/or a polishing head, one or more of which include a mucous membrane massager on the obverse side.

### RELATED APPLICATIONS

Priority is claimed from U.S. Provisional Patent Application No. 61/657,117, entitled “Canine Dental Tool and Method of Canine Dentistry” and filed Jun. 8, 2012, the entirety of which is incorporated by reference herein.

### BACKGROUND OF THE INVENTION

1. Field of Invention

The invention pertains to veterinary medicine, and more particularly to veterinary dentistry for at home (non-clinical) or professional (clinical) use by dog owners, groomers, etc.

2. Description of Related Art

As the cost of veterinary dental care increases, many families are finding dental care for their pets to be cost prohibitive. Families with pets must constantly balance the cost of their pets dental care with other major bills, as the cost of a dental cleaning (either with or without extractions and radiographs) can range from $600-$3000 for one treatment and are recommended one to two times a year prophylactically. Even with pet insurance, which is itself costly and very difficult to obtain, pet insurance typically covers approximately less than a third of the cost of a dental procedure (depending on the insurance plan). Even with insurance, many pet owners opt to not have dental procedures done because of the cost, thus compromising the dogs' oral health.

Unlike humans, dogs develop a mineralized plaque and tartar build-up (called calculus) that has the consistency of paint chips, and is adhered onto the enamel surface of the tooth, similar to dried plaster. This mineralized plaque cannot simply be brushed away. Calculus is comprised of proteins and glycoproteins that are deposited from saliva and gingival fluid, and initially adheres to the tooth in the form of a pellicle which attracts aerobic gram-positive bacteria and forms plaque. The plaque thickens and mineralizes transforming into rough and irritating calculus which allows for further proliferation of anaerobic bacteria, which release endotoxins and results in further gingival tissue destruction as well as periodontitis. This mineralized plaque is generally found on the buccal surface (the outer surface) of the teeth which come in contact with the mucous membranes of the jowls (which harbor the aerobic gram-positive bacteria), and is generally not as present on the lingual surface (the inner surface) of the teeth. This mineralization is considered a breeding ground for the bacteria that causes gingivitis, bad breath, further tooth decay, pain and further plaque and calculus build-up. Even worse, constantly swallowing a large quantity of bacteria can result in systemic pathology. This bacteria is absorbed through the gut, has a high affinity for myocardial cells, and is associated with cardiomyopathies found in dogs. There is also discussion in the veterinary community of the link between this continuous swallowing of bacteria, and overstimulation of the immune system, resulting in heightened inflammatory processes in the body. The removal of that mineralized plaque is vital to the improvement in the dog's oral and overall health.

Another reason in-hospital dental procedures have poor owner compliance, and dental procedures are often foregone, is the emotional and physical stress placed on the animal. In a hospital, general anesthesia of the dog is required to perform a dental procedure. Many animals have pre-existing health problems that involve cardiomyopathy, hypertension, liver, kidney, or lung pathology that makes them poor-candidates and high-risk patients for general anesthesia. Their health problems are weighed with the necessity for dental plaque removal under general anesthesia. Additionally, placing any mammal under general anesthesia is extremely hard on the body's systems. Brushing every day can help delay calculus build-up, however it cannot fully prevent it, and it is an ineffective means of resolving plaque build-up that has already developed. The dental procedure is also emotionally stressful for the dog. Dogs are very intuitive bright animals, who find it very traumatic to be isolated from their families (whom they perceive as their pack) and placed in the noisy busy clinical setting of a hospital to have a strenuous procedure (intubation, sedation, catheterization, and restraint) performed, and then to recover in the clinical atmosphere. Many vets find dogs have obvious adverse behavioral reactions to the veterinary clinic, upon returning after a dental procedure. All of this, just to remove calculus build-up in a general dental procedure.

Thus there is a problem in the art of veterinary dentistry, in that dogs need calculus-plaque removed without the costly, physical and emotional toll that discourages many owners from proceeding with veterinary dental intervention. Until now, this technology was only available in a clinical hospital atmosphere, as most professional ultrasonic scalers cost on average $30,000 upwards of $55,000 and at the very minimum of $4,500 and require outlet electricity and a professional clinician and her/his associated costs.

Finally, the dietary needs of the dog come into play. Dogs tend to be much more food compliant when they are offered soft food as opposed to hard food. The drawback to soft food is that it accelerates dental tartar, since the crunching of hard food is believed to mechanistically ‘brush’ their teeth to a certain extent. As such, some owners do not give their dogs the soft food that the dogs would prefer. As a result, a dog may not eat all of the hard food, or the hard food will sit there all day (smelling) before the dog eats it. Many owners find the odor of hard food to be objectionable. Thus, there is a long-felt need to be able to provide a dog with soft food while not worrying about a concomitant increase in dental tartar or calculus.

Currently professional grade scalers must be used with anesthesia, because their high frequency ultrasonic vibrations are so intense that they transmit high ultrasonic vibrations through the enamel into the tooth pulp, tooth root, and tooth nerve. Consequentially this is uncomfortable for the dog, and is not tolerated by dogs at all. Additionally, these high frequency vibrations are so intense that applying professional grade ultrasonic scalars to the tooth for more than five consecutive seconds can ultimately harm the tooth pulp and kill the tooth root and nerve. Therefore there is a need to provide dogs with an adequate tartar removing alternative, but not so intense that it will cause dogs discomfort, thus will not require expensive risky anesthesia, and is safer than current ultrasonic professional grade scalars out there.

### SUMMARY OF THE INVENTION

The above and other problems are solved by the invention, which is a handheld, preferably battery-operated, sonic vibrating scaler that removes hardened mineralized plaque and hardened calculus from dog's teeth. A vibrating base sends vibrations through interchangeable heads, one of which is a curved (e.g., shepherd's-hook-shaped) scaler, which preferably oscillates in a lateral movement, which will facilitate tartar removal on the buccal surface of dog's teeth. Preferably, the scaler has a flattened shovel-like tip or a very dull tapered tip.

Other interchangeable heads include a polishing head, which preferably rotates and/or pivots when then base is turned on. When used with polish, the polishing head will buff out at least some of the micro-scratches on the surface of the teeth that are facilitating calculus build-up in the future. The polishing head is preferably made from rubber or any similar resilient biocompatible material. Another interchangeable head that may be included with the invention is a toothbrush head, which also preferably rotates (pivots) when the base is turned. The toothbrush head preferably having a mucous membrane massager on the obverse side. The mucous membrane massaging surface is preferably made from rubber or any similar resilient biocompatible material. When the teeth are being brushed, the mucous membrane massaging surface can loosen micro flora and microscopic debris from the tongue and mucus membranes of the dogs' inner jowls.

The invention includes a vibrating base, that when turned on will send vibrations up through the interchangeable curved scaler head optionally having a flattened shovel-like dull tip or very dull tapered tip.

The invention also includes a rotating (pivoting) polisher head having a round suction cup-shaped polisher, which can be combined with flavored tooth polish to polish the teeth after the mineralized tartar has been removed. The vibrator also includes an interchangeable rotating toothbrush head that can be used with flavored toothpaste to brush the teeth, and is equipped with a mucous membrane massager on the back of the head, to loosen any bacteria or microscopic debris that is contributing to and perpetuating to the calculus. There are several vibration speeds, depending on how much tartar is built up. This can be used by owners in the comfort of their own home. The invention includes procedural methods of cleaning the teeth, a dental tooth chart, as well as polishes, toothpastes, and gels. One such method includes the following steps. First, a liquid gel is placed on the outer surface of the tooth with mineralized tartar, then the vibrating scaler can be placed on the mineralized tartar, with minimal pressure, the lateral scaler movement and vibrations will undermine the structural integrity of the mineralized tartar without harming the tooth itself.

In one embodiment, the invention includes a hand-held canine dental cleaning tool, having a hand-held base adapted to be held in a person's hand and a vibrating unit disposed within the base. A scaling head is disposed at a distal end of the base and in communication with the vibrating unit. When the vibrating unit vibrates, the scaling head laterally oscillates in a manner adapted to remove calculus from canine teeth when applied thereto. Preferably, the scaling head oscillates laterally, e.g., approximately 2-10 mm. More preferably, the scaling head oscillates approximately 5-7 mm at approximately 5000-10,000 Hz. In clinical trials, this level of sonic vibration has been very well tolerated by dogs of varying size, and therefore is at such a low frequency, does not disrupt the tooth pulp, tooth root, or tooth nerve, and therefore, is not detected by dog when scaling teeth. Additionally, this frequency is not intense enough to harm tooth pulp.

The scaling head is preferably curved, e.g., substantially in the shape of a shepherd's hook, a question mark, or the like. Preferably, the scaling head further includes a flattened shovel-like tip or a dull tapered tip. Either way, the point or tip of the scaling head should be relatively dull to avoid injury to the dog even when used by a lay person.

Preferably, the scaling head is removable from the base, e.g., interchangeable with a rotating polisher head having a tooth polishing surface attachable at the distal end of the base and communicable with the vibrating unit. When the vibrating unit vibrates, the rotating polisher head rotates. Additionally or in the alternative, the tool further includes a rotating toothbrush head having a toothbrush attachable at the distal end of the base and communicable with the vibrating unit, wherein when the vibrating unit vibrates, the rotating toothbrush head rotates. The polisher head may further include a mucous membrane massager disposed obverse to the tooth polishing surface. Additionally or in the alternative, the toothbrush head may further include a mucous membrane massager disposed obverse to the toothbrush.

The invention also includes a method of removing calculus or tartar from canine teeth. First, a cleaning material is placed on a canine tooth having mineralized tartar or calculus. Next, an oscillating curved scaling head is placed on the tooth having mineralized tartar or calculus with minimal manual pressure. The oscillations of the scaling head undermine the structural integrity of the mineralized tartar or calculus and remove the tartar or calculus without harming the tooth. Such lateral oscillations allow for sufficiency tartar or calculus removal with lower sonic vibrations that will not disrupt the tooth pulp and tooth nerve, making anesthesia not necessary and compliance much less expensive and much more likely.

### BRIEF DESCRIPTION OF DRAWINGS

FIG. 1a-b are schematics of one embodiment of an assembled vibrating base with attached scaler head in accordance with the invention. When turned on, the base sends vibrations to the head.

FIG. 2a is a magnified schematic of one embodiment of a detachable shepherd's-hook shaped scaler detachable head in accordance with the invention. This embodiment has a flattened shovel-like tip that tapers in thickness to facilitate leverage under the mineralized tartar.

FIG. 2b is a schematic of the detachable shepherd's-hook shaped scaler of FIG. 2a.

FIG. 2c is a schematic of one embodiment of a detachable rotating polisher head in accordance with the invention that can be alternated onto the base after-removal of mineralized plaque, and polish any micro-scratches on the tooth enamel that are contributing to the build-up of hardened mineralized plaque on the buccal surface.

FIG. 2d is one embodiment of a brush head in accordance with the invention, that when attached to the base, will rotated and brush the teeth after polishing, and brush the buccal surface teeth.

FIGS. 3a-b are rear and side elevation views of the back of a rotating brush head depicting one embodiment of a rubber gum massager that can massage the mucous membranes on the inside jowls of dogs, to loosen debris and microbial organisms that are contributing to mineralized plaque build-up. This will also prevent future build-up of mineralized plaque.

FIGS. 4a-c are rear, side, and front elevation views depicting one embodiment of the back, side, and front of an base in accordance with the invention with the attached rotating-polisher head. A rubberized handle for adequate gripping and an easy to use on/off button are located around the base. The head rotates when the base is turned on.

FIGS. 5a-c are elevational schematics depicting a detachable battery holding base, for easy and convenient replacement of batteries.

FIG. 6a-b is the back and side of a suction-cup shaped rotating detachable polisher head in accordance with the invention, which is equipped with a rubber gum massager that can massage the mucous membranes on inside jowls of the dogs, to loosed debris and microbial organisms that are contributing to mineralized plaque build-up and prevent future build-up.

FIG. 7a is a perspective schematic of antimicrobial liquid gel dispenser, with an elongated applicator tip designed for easy application to the outer surface of the tooth.

FIGS. 7b-c are perspective views of a convenient finger-fitting polish dispenser in accordance with the invention that can provide easy access to the polish when polishing the teeth after tartar removal in order to eliminate micro-scratches and prevent future tartar build-up.

FIG. 8 is a dental tooth chart, to provide guidance and education of dental anatomy to the owner, as they remove tartar.

FIGS. 9A-D are schematic illustrations of the lateral oscillation of the scaling heads of FIGS. 1 and 2.

### DETAILED DESCRIPTION OF THE INVENTION AND DRAWINGS

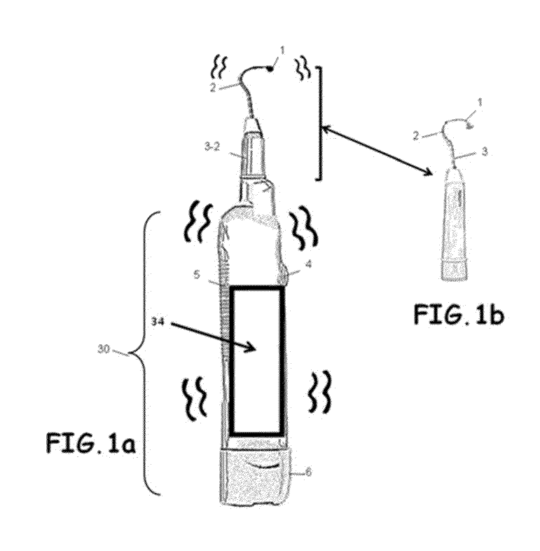

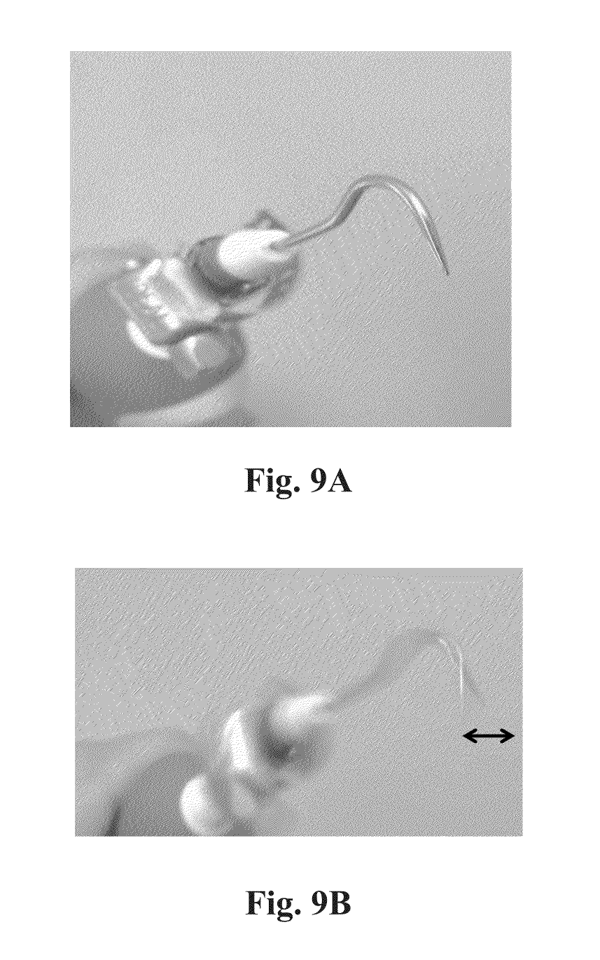

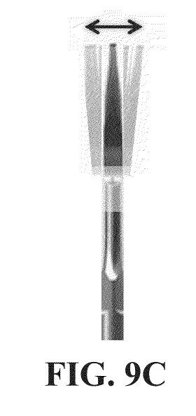

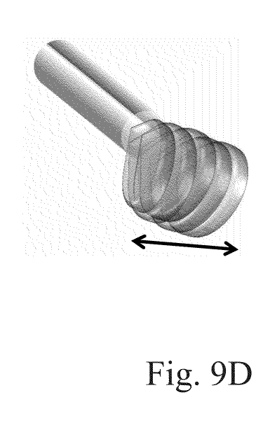

Description will now be given with reference to the attached FIGS. 1-9. It should be understood that these figures are exemplary in nature and in no way serve to limit the scope of the invention, which is defined by the claims appearing hereinbelow.

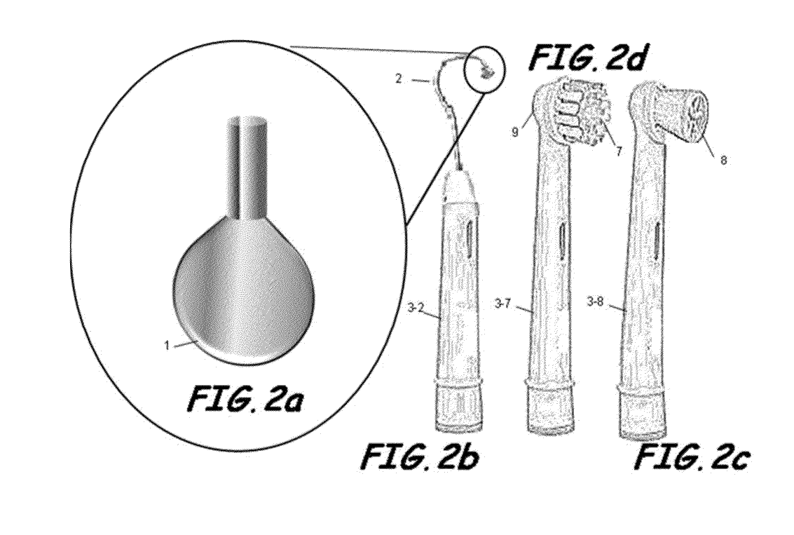

The interchangeable stainless steel scaler head as shown in FIG. 2a (see FIG. 2b), of the invention is a curved scaler head 2, preferably shepherd's-hook shaped, optionally with a flattened shovel like dulled tip 1. FIG. 1b is a schematic of the detachable shepherd's-hook shaped scaler detachable head, with a flattened shovel-like tip that tapers in thickness. The flattened shovel-like tip that tapers in thickness at its apex, as seen in FIG. 2a-b, precludes jabbing gums while providing a safe leverage into mineralized tartar. This flattened tip is not sharp in contrast to conventional professional-grade scalers that have a pointed tip at the end, and require sedation by the patient, and which cannot be used by a lay person or ordinary pet owner without serious risk of injury to the patient.

The scaler head 2, can be attached to the base 30, seen in FIG. 1a, the assembled vibrating base with attached scaler head. When the vibrating base 30, is turned on using the “ON/OFF” button 4, the battery operated motor 34, provides vibrations, which are transmitted from the base 30 to the head of the scaler 3-2, up through the base and curvature of the scaler 2, 3. When the scaler is applied to the buccal (outer) surface of a canine tooth to remove tartar, and dragged against the hard dental tartar on a dogs tooth while nominal pressure is applied, the vibrations will be strong enough to compromise the integrity of the plague, without harming the tooth, similarly in effect to that of a clinical dental procedure. This will facilitate removal of the tartar while the hook and its flattened tip scrape the tartar. An antimicrobial liquid gel is preferably placed on the tooth first to nullify friction and heat. Because dogs generally only build-up extensive tartar on the buccal (outer) surface of the tooth, this application is preferably designed for the outer surface of the tooth. Preferably, vibrating base 30 causes the scaler head to oscillate, i.e., move back and forth. Oscillations are preferably 5-7 mm but may range as much as 2-10 mm. Preferably, the vibrating base vibrates at 5000-10,000 Hz. This is in contrast to much higher intensity vibrations of professional scalers, which do not substantially oscillate at all.

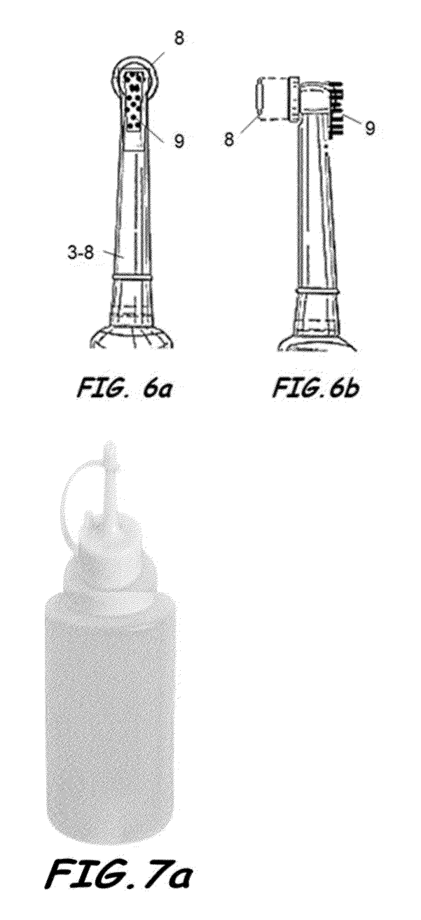

The handheld vibrator includes an attachable rotating polisher head 8, shown in FIG. 2c. The polisher head 3-8, attaches to the vibrating base 30, and has a round suction cup-shaped head 8, which rotates and can be combined with flavored tooth polish to polish the teeth after the hardened tartar has been removed by the scaler. With the use of an included polisher, the polisher head eliminates micro-scratches on the tooth enamel, to leave the surface clean and smooth, and significantly discourage future tartar build-up (because without micro-scratches, tartar and bad breath causing bacteria will no longer be able to stick to the tooth enamel). The polisher head 8, is equipped with mucous membrane massager 9, seen in FIG. 4a-c and FIG. 6a-b is located on the back of the rotating toothbrush head. Mucous membrane massager 9 is preferably made from rubber or a similar resilient and biocompatible material.

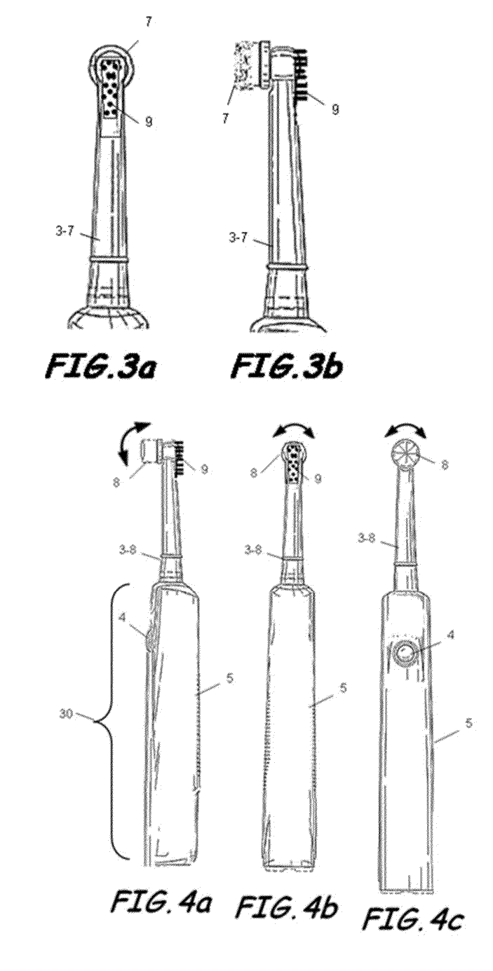

The vibrator preferably also includes an interchangeable toothbrush head 7, 3-7, as shown in FIG. 2d, which when attached to the base 30, can rotate in a similar fashion as the polisher head as seen in FIG. 4a-c. This is to be used with canine preferred flavored toothpaste, after polishing. The toothbrush head 3-7, preferably also includes a mucous membrane massager on the other side of the head as shown in FIG. 3a-b. (Mucous membrane massager 9 may be disposed on the rear side of either the toothbrush head 7, the polisher head 8, or both for maximum effect.) Because the mucous membrane and tongue surfaces of the dogs mouth are main breeding grounds for harmful bacteria which attack teeth & gums producing gingivitis, dental tartar, and the common noted odor of “dogs breath”, mucous membrane brushing is vital, in addition to tooth brushing, for a thorough dislodging of the plaque, mucus, and bacteria that would cause further plaque and halitosis. The rubber mucous membrane massager 9, seen in FIG. 3a-b and FIG. 2d is located on the back of the rotating toothbrush head, so that calculus contributing bacteria, mucous and microscopic debris will be loosened while brushing the dogs' teeth. This facilitates dual purpose mucous membrane massage that can be accomplished quickly and easily during tooth brushing, which will also prevent future build-up of mineralized plaque.

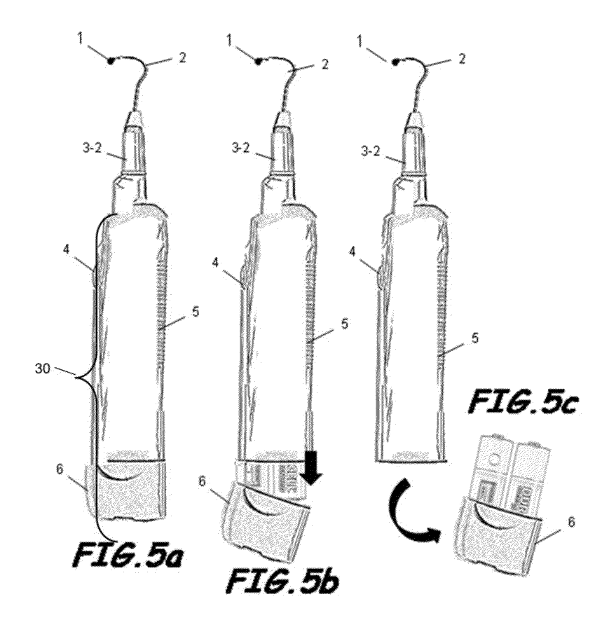

The base 30 is preferably battery operated, so that batteries can be replaced as shown in FIG. 5a-c. The base 30, can open for the replacement of one or more batteries. In addition or in the alternative, the batteries can be rechargeable, and the device can sit in a charging station or otherwise plug into an outlet when not in use. Other power supply options are also contemplated as being within the scope of the invention. The base 30, is equipped with a rubberized grip 5, that makes maneuvering and holding the base easier and more comfortable. There are three speeds of vibration that can be achieved, so that the vibration can be varied depending on how much tartar build-up there is. Owners can use this vibrator on their canine pets in the comfort of their own home. The invention includes procedural methods of cleaning the teeth, a teeth chart, as well as a polish, toothpaste, and gel.

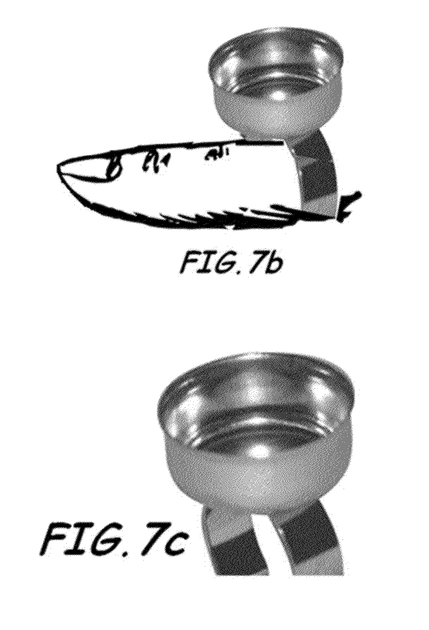

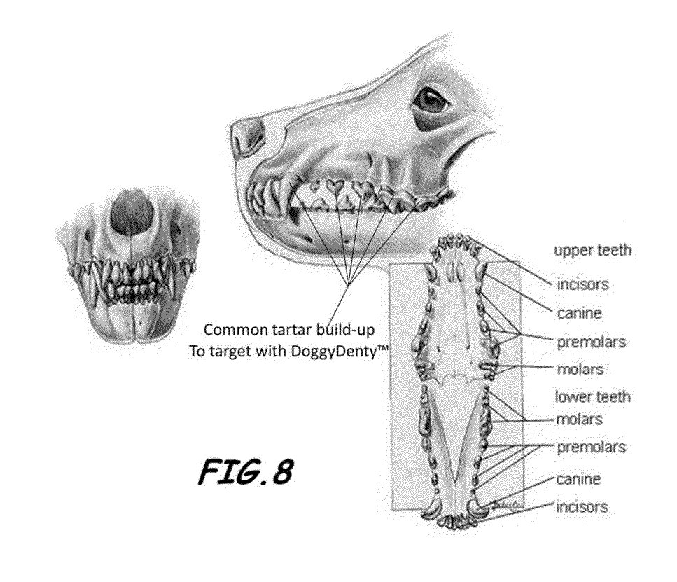

In operation the invention is used as follows. First, the user applies the antimicrobial breath freshening gel FIG. 7a, to the outer surface of the dogs teeth. Place the interchangeable stainless steel scaler detachable head 3-2, onto the base 30. Press the “ON/OFF” button 4, on the vibrating base to provide gentle vibrations which cause the scaler head to oscillate on the order of several millimeters. Apply the now vibrating scaler 3-2, the buccal (outer) surface of a canine tooth where tartar is seen (see FIG. 8). While applying pressure, scrape off tartar by dragging the shepherds-hook 2, and shovel-like tip 1, against the hard dental tartar on a dogs tooth. While pressure is applied, the vibrations will be strong enough to compromise the integrity of the plague, without harming the tooth, similarly as done in a clinical dental procedure. Tartar removal should be facilitated by hook 2. It is preferred to ensure that the tooth remains well lubricated with the antimicrobial liquid gel FIG. 7a; if not, apply more gel to the tooth. Because dogs generally only build up extensive tartar on the buccal (outer) surface of the tooth, this application is preferably designed for the outer surface of the tooth.

After removal of the tartar is sufficient, with the base 30, turned OFF 30, attach the round suction cup-shaped rotating polisher head 3-8, to the vibrating base 30. Scoop some flavored tooth polish into the polisher cup FIG. 7c, which can easily slide onto your finger for easy polish access FIG. 7b. Press round suction cup-shaped rotating polisher head 3-8, into polisher cup FIG. 7c, to scoop polish onto the round suction cup-shaped polisher head 8, then press suction cup-shaped polisher head 8, onto the outer surface of the dogs' tooth, where the tartar was removed by the scaler 3-2, and press the ON/OFF button 4, on the base of the vibrator 30. Rotations of the polisher head eliminate micro-scratches on the tooth enamel, to leave the surface clean and smooth and significantly discourage future tartar build-up. Without micro-scratches, tartar and bad breath causing bacteria will not stick as easily to the tooth enamel. While polishing, the rubberized mucous membrane massager 9, on the back of the brush 3-7, is loosening micro-debris and micro-organisms on the mucous membranes that are facilitating future tartar and halitosis (bad breath).

Once polishing is done, attach the interchangeable toothbrush head 3-7, onto the vibrating base 30, which rotates in a similar fashion as the polisher head 3-8. Using the flavored toothpaste, after polishing, brush the teeth clean.

### Features:

The base is preferably equipped with a rubberized grip, that makes maneuvering and holding the base easier and more comfortable.

Mucous membrane massager. Because the mucous membranes and tongue surfaces of the dogs mouth are main breeding grounds for harmful bacteria which attack teeth & gums producing gingivitis, dental tartar, and the common noted odor of “dogs breath”, mucous membrane brushing is vital, in addition to tooth brushing, for a thorough dislodging of the plaque, mucus, and bacteria that would cause further plaque and halitosis. The rubber mucous membrane massager(s) are located on the back(s) of the rotating toothbrush head and/or rubber polisher head, so that calculus contributing bacteria, mucous and microscopic debris will be loosened while brushing/polishing the dog's teeth. This facilitates dual purpose mucous membrane massage that can be accomplished quickly and easily during tooth brushing/polishing, which will also prevent future build up of mineralized plaque.

Optionally, there are multiple (e.g., three) speeds of vibration that can be achieved, so that the vibration can be varied depending on how much tartar build up there is.

Owners can use this vibrator on their canine pets in the comfort of their own home.

A tooth chart, non-xylitol polish, toothpaste, and gel are included.

The invention is not limited to the above description. For example, the scaler head is described as being curved (e.g., like a shepherd's hook), however an angled scaler head (e.g., like the numeral 7, or a letter L), or any other convenient geometry may be employed.

Having described certain embodiments of the invention, it should be understood that the invention is not limited to the above description or the attached exemplary drawings. Rather, the scope of the invention is defined by the claims appearing hereinbelow and includes any equivalents thereof as would be appreciated by one of ordinary skill in the art.

What is claimed is:

1. A hand-held canine dental cleaning tool, comprising:
a hand-held base adapted to be held in a person's hand;
a vibrating unit disposed within said base;
a scaling head disposed at a distal end of said base and in communication with said vibrating unit,
wherein when said vibrating unit vibrates, said scaling head oscillates in a manner adapted to remove calculus from canine teeth when applied thereto.

2. A hand-held canine dental cleaning tool according to claim 1, said scaling head oscillating laterally.

3. A hand-held canine dental cleaning tool according to claim 2, said scaling head oscillating approximately 2-10 mm.

4. A hand-held canine dental cleaning tool according to claim 3, said scaling head oscillating approximately 5-7 mm.

5. A hand-held canine dental cleaning tool according to claim 2, said scaling head oscillating approximately 5000-10,000 Hz.

6. A hand-held canine dental cleaning tool according to claim 1, said scaling head being curved substantially in the shape of a shepherd's hook.

7. A hand-held canine dental cleaning tool according to claim 6, said scaling head further comprising a flattened shovel-like tip.

8. A hand-held canine dental cleaning tool according to claim 1, wherein said scaling head is removable from said base.

9. A hand-held canine dental cleaning tool according to claim 8, said head is interchangeable and said tool further comprising a rotating polisher head having a tooth polishing surface attachable at said distal end of said base and communicable with said vibrating unit, wherein when said vibrating unit vibrates, said rotating polisher head.

10. A hand-held canine dental cleaning tool according to claim 8, said head is interchangeable and said tool further comprising a rotating toothbrush head having a toothbrush attachable at said distal end of said base and communicable with said vibrating unit, wherein when said vibrating unit vibrates, said rotating toothbrush head rotates.

11. A hand-held canine dental cleaning tool according to claim 9, said polisher head further comprising a mucous membrane massager disposed obverse to said tooth polishing surface.

12. A hand-held canine dental cleaning tool according to claim 10, said toothbrush head further comprising a mucous membrane massager disposed obverse to said toothbrush.

13. A hand-held canine dental cleaning tool according to claim 1, said scaling head being curved and having a dull tapered tip.

14. A method of removing calculus or tartar from canine teeth, comprising the steps of:
placing a cleaning material on a canine tooth having mineralized tartar or calculus;
placing an oscillating curved scaling head on the tooth having mineralized tartar or calculus with minimal manual pressure,
wherein the oscillations of the scaling head undermine the structural integrity of the mineralized tartar or calculus and remove the tartar or calculus without harming the tooth.
